(19) United States
(12) Patent Application Publication
(10) Pub. No.: US 2008/0086065 A1
(43) Pub. Date: Apr. 10, 2008

(54) Cough assistance and airway clearance device

(76) Inventors: Karen B. Holm, Manhasset, NY (US); Robert Holm, Manhasset, NY (US); Brian McLaughlin, Portland, ME (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/907,067

(22) Filed: Oct. 9, 2007

Related U.S. Application Data
(60) Provisional application No. 60/849,944, filed on Oct. 6, 2006.

(51) Int. Cl. A61H 23/00

(52) U.S. Cl. 601/107

(57) ABSTRACT

A portable, handheld device for manual percussive respiratory therapy in infants and young children having a pear-shaped dome for proper position of the device over various sizes of target treatment anatomy, an ergonomic handle for maximum efficacy in implementation by a range of users, a cushioned sealing mechanism for softening the impact on a young patient, and indicator means to indicate proper positioning and engagement of the device during use. The device is optimal for use by parents and other caregivers with little or no medical training.

### CROSS-REFERENCE TO RELATED APPLICATIONS

This application claims priority to a provisional U.S. patent application entitled, “Cough Assistance, Airway Clearance Device”, filed Oct. 6, 2006, having a Ser. No. 60/849,944, the disclosure of which is hereby incorporated by reference in its entirety.

### FIELD OF THE INVENTION

The present invention relates generally to an apparatus and method directed to the treatment of respiratory congestion in infants and young children due to the accumulation of mucus in the bronchioles from various viruses and diseases. More particularly, the present invention relates to an ergonomic, portable, hand-held, and pliable device configured to non-injuriously and effectively clear the airways of infants and young children through accurate positioning and coverage over the target treatment areas.

### BACKGROUND OF THE INVENTION

This disclosure relates to the treatment of respiratory congestion in infants and young children due to bronchiolitis and similar viruses and diseases, such as cystic fibrosis, that cause accumulation of mucus in the bronchioles (air passages leading to the lungs) and in the lungs. This invention utilizes the principles of chest physiotherapy, whereby body positioning and percussive force are applied to the chest using a cupped hand to move mucus and to stimulate coughing to clear a patient's airways. Accordingly, this invention is a hand-held pear and dome-shaped device, made of highly-pliable material for curving around the ribcage, thereby enabling effective movement of mucus to assist in airway clearance.

Bronchiolitis, often caused by the Respiratory Syncytial Virus (RSV), is one of the leading causes of the need for urgent medical treatment in infants and young children. For these small patients, there is little medical assistance that can be provided other than aspirating the nasal passages to relieve congestion, and ensuring that the child is receiving sufficient fluids and oxygen. Traditional chest physiotherapy is sometimes used, however, this technique is not well understood by parents and is not always embraced, as the treatment requires some force on the child's lungs and body to relieve congestion and clear the airways.

There are a number of different devices and designs that employ the principles of chest physiotherapy and pulmonary percussion to help dislodge and loosen secretions and/or mucus from the lungs and chest. Early methods and devices to treat conditions and diseases such as bronchiolitis and cystic fibrosis implemented chest physiotherapy and percussion for the reduction and removal of accumulated mucus. Such methods and devices were often primitive and were applied with great physical force to achieve optimal efficacy, resulting in unwarranted physical injury to the patient undergoing treatment.

U.S. Pat. No. 4,429,688 (the '688 patent) issued to Duffy is an exemplary application of such early forms of percussive therapy. This device is a hand-held manual percussive instrument. It is circular in shape and provides a knob handle to assist in gripping the device for delivering chest physiotherapy. This instrument incorporates a compressible gaseous vapor within the cavity of the device to cushion the skin from the compressive forces of the instrument. An embodiment of the device resembles a plunger and requires the user to drive an attached shaft into the percussive instrument to deliver force to the target treatment region. The large contact area of this apparatus and similar devices made them unsuitable for the treatment of infants and young children whose soft bones and delicate skin rendered them susceptible to significant injury from repetitive engagement of the device.

Moreover, the oversized contact area made proper positioning over the desired treatment area of a young patient unlikely, if not impossible. The plunger-like embodiment of the '688 patent also possessed the potential to cause horrific injury to infants and children due to the massive downward energy created through the powerful push of the shaft to the main body of the percussor device.

U.S. Pat. No. 4,196,722 (the '722 patent) issued to Vanderwoude for “Percussion Instrument Used in Respiratory Therapy” discloses a hand-held manually operated percussive instrument for chest physiotherapy in the form of a percussor cup with a rounded high bell shape. The therapist or caregiver would tightly grip the top end of the dome with his or her fingers and would swing the cup, while gaining momentum through the air in a single stroke to land with a strike against the patient's target treatment air. The bell shape of the percussor cup provides limited means for accuracy over the target area on a young patient as there is no differential in size of the cup at the point of contact of the device with the patient's skin. Use of this device results in over-treating the patient as the target and surrounding unaffected area are repeatedly treated causing ineffective treatment of the suffering area and possible inflammation of the unaffected surrounding area, which may or may not be able to withstand the repetitive compression effects of the device.

U.S. Pat. No. 4,745,910 to Day et al., issued in 1988, is directed to a percussor and methods to aid in the removal of lung secretions. As early as 1980, as evidenced in the disclosure of the '722 patent, persons of ordinary skill in the art were aware that an apparatus that required significant forearm movement caused momentous forces harmful to young patients Nevertheless, the Day percussor seeks to remove undesired lung secretion accumulation in infants and young children via the utilization of a hammer-like handle and a bell-shaped percussor at the end of the handle. This apparatus did not address the long-felt need for improvement in gentler, non-injurious administration of chest physiotherapy on infants and children. Rather, it achieved only a modification of the then-traditional percussor cup to gain a slight advantage over previous devices in the size of percussor cup used.

These prior art devices require full grasping and significant involvement of the arm to deliver the percussive therapy, and present a number of problems during implementation on a young patient such as an infant or a child. Subsequent devices invented over the past twenty years, such as those disclosed in U.S. Pat. Nos. 5,261,394, 5,606,754, 6,098,222, 6,290,660, and 7,232,417, incorporate traditional chest physiotherapy along with vibration and acoustic technology. These devices did not solve the need for improvement of the percussor devices set forth above, but sought to reduce chest and lung bronchiole congestion through new vibration and acoustic methods. These new therapies functioned via increasingly complex mechanical and electronic devices, which are not befitting for implementation by a parent or other caregiver with little or no medical training.

The vibration and acoustic technologies were also ill-equipped to solve the need for a device directed to the treatment of an infant or young child. These technologies are ill-suited for use on infants and young children, who are generally unable to breathe forcefully into these devices and exhale against an escalating incoming air flow in an attempt to loosen accumulated mucus. The vibration technology itself is extremely dangerous for use on infants as their bones and surrounding supportive tissue and cartilage are neither solidified nor are strong enough to withstand the vibration forces of these devices.

Accordingly, the invention disclosed herein provides parents and caregivers with a gentler, hand-held device to administer chest physiotherapy to clear the airways. Unlike other instruments, this device uses highly pliable material to reach the air passages more effectively. It provides a unique handle to enable a number of gripping options. The base of the dome is cushioned to protect the skin from irritation by creating an air pocket of protection. The shape of the dome enables treatment to reach the large and small portions of the lobes of the lungs. The device may be configured in a number of sizes to facilitate the most effective treatment.

Accordingly, it is an object of the invention to provide a simple percussive therapy device that is easily utilized by a novice, parent, or other caregiver on an infant or young child without the need for intensive medical training.

Another object of the invention is to provide for the greatest flexibility in hand and wrist movement.

It is further an object to provide an alternative treatment means for administering chest physiotherapy to small areas of a young patient's anatomy.

Another object of the invention is to provide an indicator to signal proper compressive engagement of the invention with the patient's skin.

Still another object of the invention is to provide a percussive therapy device that is utilized to convert accumulated mucus or phlegm solids into a viscous form that can be exited through the patient's respiratory or waste elimination systems.

### SUMMARY OF THE INVENTION

The foregoing needs are met, to a great extent, by the present invention, wherein in one aspect an apparatus is provided that in some embodiments comprises a portable, handheld device for manual percussive respiratory therapy.

In accordance with one embodiment of the present invention, a portable, handheld device for manual percussive respiratory therapy is provided comprising a dome having a smaller proximal portion and a larger distal portion, an ergonomic handle accessible from an outer surface of the dome and having central and end portions wherein the central portion is contiguous and adjacent to each end portion such that each end portion meets the outer surface of the dome, and further wherein a width of the handle expands gradually from the central portion towards the end portions, and a compressive area about the dome wherein a base of the compressive area is surrounded by a cushioned air sealing mechanism having a smaller proximal portion and a larger distal portion for fitted engagement with the dome.

In accordance with another embodiment of the present invention, a portable, handheld device for manual percussive respiratory therapy is provided comprising a dome having a smaller proximal portion and a larger distal portion, an ergonomic handle accessible from an outer surface of the dome and having central and end portions wherein the central portion is contiguous and adjacent to each end portion such that each end portion meets the outer surface of the dome, and further wherein a width of the handle expands gradually from the central portion towards the end portions, a compressive area about the dome wherein a base of the compressive area is surrounded by a cushioned air sealing mechanism having a smaller proximal portion and a larger distal portion for fitted engagement with the dome and further wherein the cushioned air sealing mechanism is removably attached to the base of the compressive area, and indicator means within the dome to indicate proper positioning and compression of the device during implementation.

In accordance with an additional embodiment of the present invention, a portable, handheld device for manual percussive respiratory therapy in infants and young children is provided comprising a dome having a smaller proximal portion and a larger distal portion such that the proximal and distal portions are applied respectively to appropriately sized treatment areas of an infant or child patient, an ergonomic handle accessible from an outer surface of the dome and having central and end portions wherein the central portion is contiguous and adjacent to each end portion such that each end portion meets the outer surface of the dome and further wherein a width of the handle expands gradually from the central portion towards the end portions, compressive area about the dome herein a base of the compressive area is surrounded by a cushioned air sealing mechanism having a smaller proximal portion and a larger distal portion for fitted engagement with the dome and further wherein the cushioned air sealing mechanism is removably attached to the base of the compressive area, a plurality of compression coils positioned within the cushioned air sealing mechanism for maximum sealing efficacy; and indicator means within the dome to indicate proper positioning and compression of the device during implementation.

In accordance with another embodiment of the present invention, a portable, handheld device for manual percussive respiratory therapy is provided with a dome having a smaller proximal portion and a larger distal portion, a plurality of ergonomic handles accessible from an outer surface of the dome wherein a width of the handles expands gradually from an end of each handle to a base of each handle, a compressive area about the dome wherein a base of the compressive area is surrounded by a cushioned air sealing mechanism having a smaller proximal portion and a larger distal portion for fitted engagement with the dome and further wherein the cushioned air sealing mechanism is removably attached to the base of the compressive area; and indicator means within the dome to indicate proper positioning and compression of the device during implementation.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a top view of a manual respiratory device according to a preferred embodiment of the invention.

FIG. 2 is a perspective view illustrating the device shown FIG. 1, showing the handle and dome isometrically according to a first aspect of a preferred embodiment of the invention.

FIG. 3 is a perspective view of a cross section through section A-A of FIG. 1 according to a first aspect of a preferred embodiment of the invention.

FIG. 4 is a cross section through a section perpendicular to that of FIG. 3 according to a preferred embodiment of the present invention.

FIG. 5 is a perspective view illustrating the interior of the dome according to a preferred embodiment of the invention.

FIG. 6 is a photograph of an exemplary prototype of the manual respiratory device according to a second embodiment of the invention.

FIG. 7 is a perspective view of a manual respiratory device according to a third embodiment of the invention.

FIG. 8 is a side view illustrating the device shown FIG. 8, according to a first aspect of a third embodiment of the invention.

FIG. 9 is a perspective view of the back of the distal portion of the device according to a first aspect of a third embodiment of the invention.

FIG. 10 is a top view of a device according to a third embodiment of the present invention.

FIG. 11 is a cross section through a section perpendicular to that of FIG. 10 according to a third embodiment of the present invention.

FIG. 12A is a first exemplary view illustrating a side of the device according to a first aspect of a fourth embodiment of the invention.

FIG. 12B is a second exemplary view illustrating a side of the device according to a first aspect of a fourth embodiment of the invention.

FIG. 13A is a perspective view illustrating the distal portion of the device according to a first aspect of a fifth embodiment of the invention.

FIG. 13B is an exemplary side view of the device according to a first aspect of a fifth embodiment of the invention.

### DETAILED DESCRIPTION

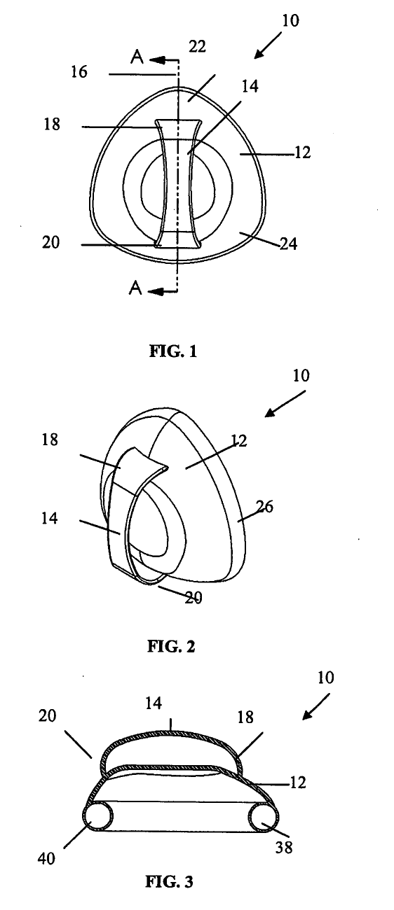

The invention will now be described with reference to the drawing figures, in which like reference numerals refer to like parts throughout. An embodiment of the present inventive apparatus and method for the use of the inventive apparatus is illustrated in FIG. 1. Referring now to FIG. 1, therein depicted is a manual respiratory device 10 provided for use in aiding airway clearance according to a preferred embodiment of the present invention. Device 10 has a dome having an outer shell 12 and an inner shell 28. The dome is manufactured with injection molding methods and a shape retaining synthetic resinous material, such as Acrylonitrile Butadiene Styrene (ABS).

In a first embodiment of the present invention, a handle 14 of substantially uniform relative wall thickness is attached to the dome. The handle 14 varies in width from the central horizontal cross section 16, taken along line A-A and viewable in FIG. 1, to ends 18 and 20 that contact the dome. This provides an expanding contact surface area along the handle 14 so that a variety of users can use the inventive apparatus optimally. Users with smaller hands can position their hands along the central portion of the handle 14 for maximum effectiveness. Users with larger hands do not need to grip the handle 14 tightly as placement on the expanding contact areas towards ends 18 and 20 will allow these users to maintain a natural hold on the handle during implementation of the apparatus. The handle 14 provides a method by which the device 10 may be used in a most effective way, by sliding a user's fingers around the handle 14 to provide for the greatest flexibility in palm and wrist movement. There is no grasping required, therefore the full motion of the user's hand is available to deliver percussive therapy.

The dome is configured in the form of a pear wherein the proximal portion 22 of the dome has a radius smaller than that of the central portion of the dome to allow for better contact with the smaller lobes of the lungs and to better assist in flexing around the rib cage of patients. The distal portion 24 of the dome has a radius greater than that of the central portion of the dome. Application of the distal portion 24 of the dome to the patient allows for treatment of a larger surface area when desired. The ability to alternate from the smaller proximal portion 22 to the greater distal portion 24 not only allows for variance in treatment surface area, but also provides options for a range in the number of repetitive applications of the treatment to desired target areas.

Due to the reduced size of the smaller proximal portion 22, lessened and gentler compression forces are applied to the young patient when using this segment, and thus may be applied with greater repetitions without the risk of injury, if such repetitions are necessary to obtain optimal dispersion of the lung or chest congestion. Similarly, application of the larger distal portion 24 may require lesser repetitions during treatment as a larger target area is impacted with each compression application.

The base of the dome meets the compressive area 26 of the device 10 that contacts the patient's chest or other desired target treatment area. A side view of the compressive area 26 is depicted in FIG. 2. FIGS. 3 through 6 illustrate varying perspective views of the compressive area 26 to demonstrate the features within. A pictorial of a frontal view of compressive area 26 is illustrated in FIG. 5 and consists of an annular loop or hollow ring 28 The loop or ring 28 is formed through injection molding methods, and is a latex or similar soft synthetic rubber material that is highly yieldable, resilient, and wear-resistant. The loop or ring 28 is cushioned and compressible to absorb the impact force as the device 10 is placed on the patient's skin and to provide a soft and non-abrasive contact area for the device 10.

FIG. 3 shows a perspective view of a cross section through line A-A 16 of FIG. 1. In the proximal portion 22 and distal portion 24, compression coils 38 and 40 are placed within the loop or ring 28. When the device 10 is engaged with a patient's skin, the cushion of loop or ring 28 compresses to soften the impact of the device 10 against the skin. The compression coils 38 and 40, which are made of a material slightly denser than that of loop or ring 28, resist full compression of the loop in the surrounding region to create an air-tight seal between the device 10 and the patient's skin.

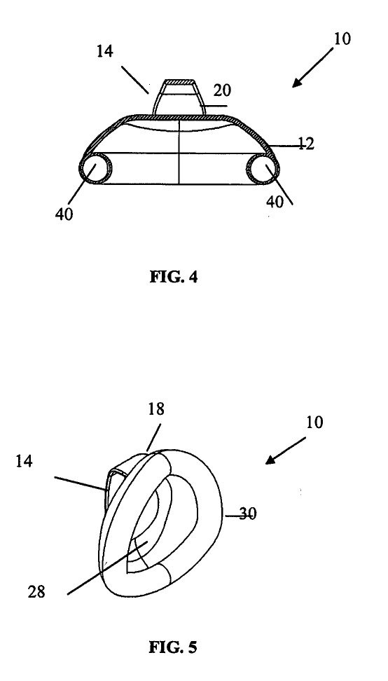

FIG. 4 is a cross section through a section perpendicular to that of FIG. 3 according to a preferred embodiment of the present invention. Therein, at least one compression coil 40 is viewable on the left and right segments of the device 10.

FIG. 5 is a perspective view illustrating the interior 30 of the dome according to a preferred embodiment of the invention. The annular loop or ring 28 is viewable such that it extends in a three-dimensional manner to illustrate its cushioned properties.

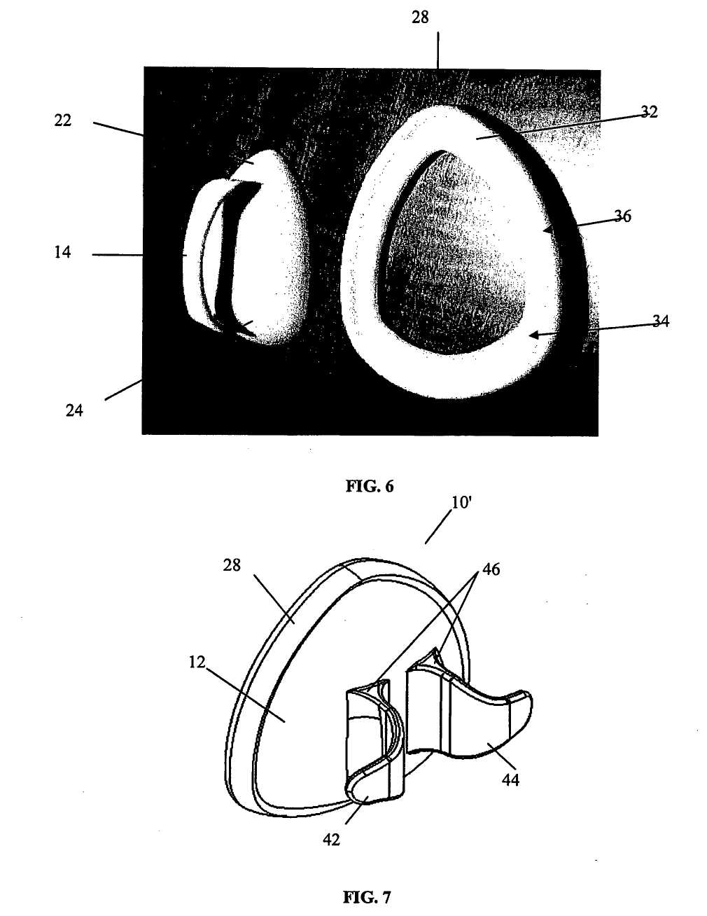

FIG. 6 is a photograph of a physical model of the manual respiratory device according to a second embodiment of the invention. The photograph shows the annular loop or ring 28 as removably attached to the compressive area 26 of the device. The attachable loop or ring is configured similarly to the compressive area 26, in that it has a smaller proximal portion 32 and a larger distal portion 34 to fit the dimensions of compression area 26. The rim 34 allows the loop or ring 28 to fit tightly over the compression area 26 so as to remain fully attached during implementation of the device 10.

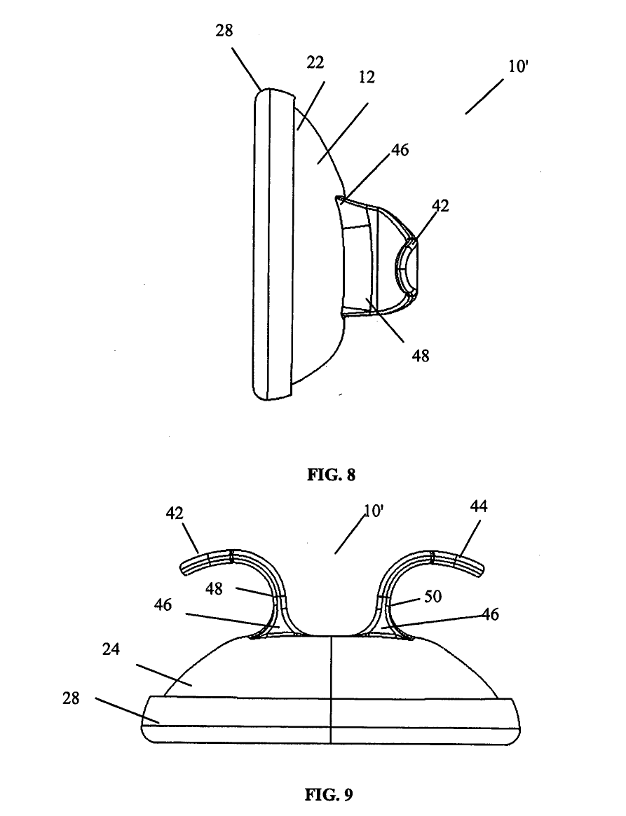

In a third embodiment of the present invention, and with reference to FIG. 7, a manual respiratory device 10′ is provided with a left handle 42 and a right handle 44 attached to a flat portion of the outer shell 12 of the dome. The ergonomic handles 42 and 44 are curved and vary in width from the end of the handles to the base 46. The end of the handles 42 and 44 form the narrowest portion, as the width increases gradually towards the base 46. A side view of the device according to this embodiment is illustrated in FIG. 8. FIG. 8 shows handle 42, wherein an inner surface 48 is viewable. The side view is exemplary of the increasing handle width from the end of the handle to the base 46.

The expanding contact surface areas along the handles 42 and 44 are provided so that a variety of users can use the inventive apparatus optimally. Users with smaller hands can position their hands along the curve of handles 42 and 44 for maximum effectiveness. Users with larger hands do not need to grip the handles 42 and 44 tightly as placement on the expanding contact areas towards the bases 46 will allow these users to maintain a natural hold on the handle during implementation of the apparatus. The handles 42 and 44 provides a method by which the device 10′ may be used in a most effective way, by sliding a user's fingers around handles 42 and 44 to provide for the greatest flexibility in palm and wrist movement. There is no grasping required, therefore the full motion of the user's hand is available to deliver percussive therapy.

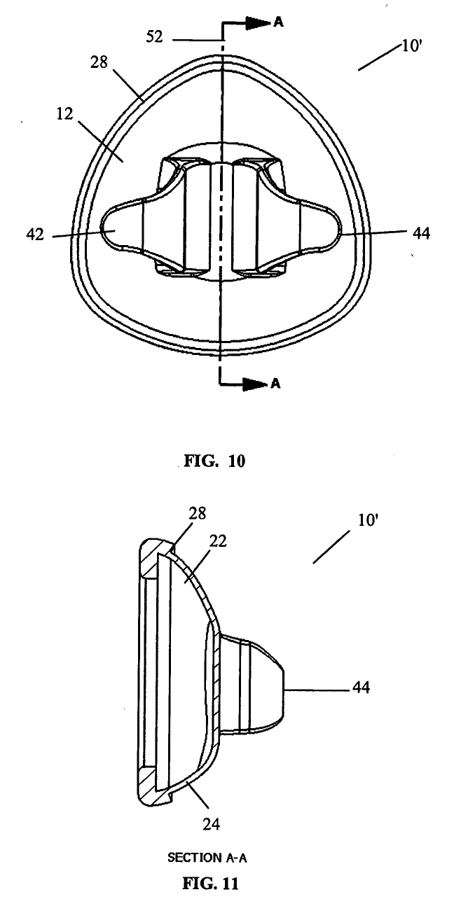

FIG. 9 shows a perspective view of the distal portion 24 of the device wherein the inner surfaces 48 and 50 of the handles 42 and 44 are shown respectively. A top view of the device according to a third embodiment of the invention is presented in FIG. 10, wherein a line A-A representing cross section 52 is shown. FIG. 11 shows a view along the cross section 52 wherein the outer surface of the right handle 44 is shown.

A fourth embodiment of the inventive apparatus is shown in FIGS. 12A and 12B wherein a light emitting diode (LED) 54 is embedded into the outer shell 12 of a dome of a manual respiratory device 10″. The LED 54 is initiated by way of connecting with a strain gauge that is implanted into the inner surface 28 of the shell. When the device is used, a strain is placed on the dome. Upon due strain through normal use, or minor deflection during normal use, the strain gauge detects the displacement and transmits a low voltage output. The low voltage output provides a signal to trigger the LED 54, displaying a light within the diode to indicate to the user that there is sufficient pressure for effective treatment. The operation of an LED 54 is well known in the art.

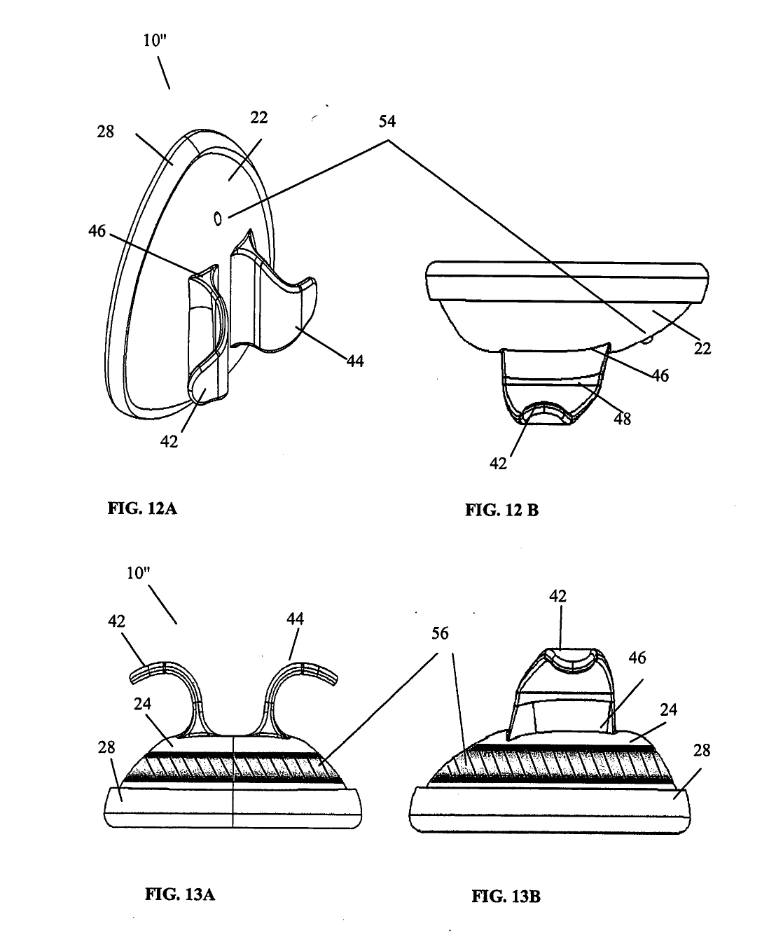

FIGS. 13A and 13B illustrate a fifth embodiment of a manual respiratory device 10′″ according to the present invention. A pressure gradient indicator 56 is embedded in the outside shell 12 of the dome of the device. The pressure gradient indicator 56 is a material that changes color due to minor deflections in the main body of the dome. When sufficient pressure is placed upon the main body of the dome, a color change in the indicator 56 alerts the user that optimal pressure has been applied. The pressure gradient indicator 56 is located in the central portion of the outside shell 12 of the dome, has an approximate thickness of ½ inch, and winds around the circumference of the outer shell 12.

Although an example of the device 10, 10′, 10″, and 10′″ are shown using a loop or ring, it will be appreciated that other yieldable, sealing agents can be used. Also, although the device is useful for chest physiotherapy, it can also be used to do other things and/or in other industries.

Many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A portable, handheld device for manual percussive respiratory therapy, said device comprising:
a dome having a smaller proximal portion and a larger distal portion;
an ergonomic handle accessible from an outer surface of the dome and having central and end portions,
wherein the central portion is contiguous and adjacent to each end portion such that each end portion meets the outer surface of the dome, and
further wherein a width of the handle expands gradually from the central portion towards the end portions; and
a compressive area about the dome,
wherein a base of the compressive area is surrounded by a cushioned air sealing mechanism having a smaller proximal portion and a larger distal portion for fitted engagement with the dome.

2. The device of claim 1, wherein the dome is manufactured with injection molding methods.

3. The device of claim 1, wherein the dome is manufactured with a shape retaining resinous material.

4. The device of claim 1, wherein the cushioned air sealing mechanism is removably attached to the base of the compressive area.

5. The device of claim 1, wherein a plurality of compression coils is placed within the cushioned air sealing mechanism.

6. The device of claim 4, wherein a plurality of compression coils is placed within the cushioned air sealing mechanism.

7. The device of claim 1, further comprising indicator means for confirming proper positioning and engagement of the device with a patient's skin.

8. The device of claim 7, wherein the indicator means is a color change visible from the outer shell of the dome.

9. The device of claim 7, wherein the indicator means is a LED located on the outer shell of the dome.

10. A portable, handheld device for manual percussive respiratory therapy, said device comprising:
a dome having a smaller proximal portion and a larger distal portion;
an ergonomic handle accessible from an outer surface of the dome and having central and end portions,
wherein the central portion is contiguous and adjacent to each end portion such that each end portion meets the outer surface of the dome, and
further wherein a width of the handle expands gradually from the central portion towards the end portions;
a compressive area about the dome,
wherein a base of the compressive area is surrounded by a cushioned air sealing mechanism having a smaller proximal portion and a larger distal portion for fitted engagement with the dome, and
further wherein the cushioned air sealing mechanism is removably attached to the base of the compressive area; and
indicator means within the dome to indicate proper positioning and compression of the device during implementation.

11. The device of claim 10, wherein the dome is manufactured with injection molding methods.

12. The device of claim 10, wherein the dome is manufactured with a shape retaining resinous material.

13. The device of claim 10, wherein a plurality of compression coils is placed within the cushioned air sealing mechanism.

14. The device of claim 10, wherein the indicator means is a color change visible from the outer shell of the dome.

15. The device of claim 10, wherein the indicator means is a LED located on the outer shell of the dome.

16. A portable, handheld device for manual percussive respiratory therapy in infants and young children, said device comprising:
an ergonomic dome having a smaller proximal portion and a larger distal portion such that the proximal and distal portions are applied respectively to appropriately sized treatment areas of an infant or child patient;
a handle accessible from an outer surface of the dome and having central and end portions,
wherein the central portion is contiguous and adjacent to each end portion such that each end portion meets the outer surface of the dome, and
further wherein a width of the handle expands gradually from the central portion towards the end portions;
a compressive area about the dome,
wherein a base of the compressive area is surrounded by a cushioned air sealing mechanism having a smaller proximal portion and a larger distal portion for fitted engagement with the dome, and
further wherein the cushioned air sealing mechanism is removably attached to the base of the compressive area;
a plurality of compression coils positioned within the cushioned air sealing mechanism for maximum sealing efficacy; and
an indicator means within the dome to indicate proper positioning and compression of the device during implementation.

17. The device of claim 16, wherein the dome is manufactured with injection molding methods.

18. The device of claim 16, wherein the dome is manufactured with a shape retaining resinous material.

19. The device of claim 16, wherein the indicator means is a color change visible from the outer shell of the dome.

20. The device of claim 16, wherein the indicator means is a LED located on the outer shell of the dome.

21. A portable, handheld device for manual percussive respiratory therapy, said device comprising:
a dome having a smaller proximal portion and a larger distal portion;
a plurality of ergonomic handles accessible from an outer surface of the dome,
wherein a width of the handles expands gradually from an end of each handle to a base of each handle;
a compressive area about the dome,
wherein a base of the compressive area is surrounded by a cushioned air sealing mechanism having a smaller proximal portion and a larger distal portion for fitted engagement with the dome, and
further wherein the cushioned air sealing mechanism is removably attached to the base of the compressive area; and
indicator means within the dome to indicate proper positioning and compression of the device during implementation.

22. The device of claim 21, wherein the dome is manufactured with injection molding methods.

23. The device of claim 21, wherein the dome is manufactured with a shape retaining resinous material.

24. The device of claim 21, wherein the cushioned air sealing mechanism is removably attached to the base of the compressive area.

25. The device of claim 21, wherein a plurality of compression coils is placed within the cushioned air sealing mechanism.

26. The device of claim 21, wherein a plurality of compression coils is placed within the cushioned air sealing mechanism.

27. The device of claim 21, further comprising indicator means for confirming proper positioning and engagement of the device with a patient's skin.

28. The device of claim 21, wherein the indicator means is a color change visible from the outer shell of the dome.

29. The device of claim 21, wherein the indicator means is a LED located on the outer shell of the dome.
